(19) United States
(12) Patent Application Publication
(10) Pub. No.: US 2025/0190977 A1
(43) Pub. Date: Jun. 12, 2025

(54) REDEEMING ENTITLEMENTS DEPLOYED ON BLOCKCHAIN

(71) Applicant: ADOBE INC., San Jose, CA (US)

(72) Inventors: David HUMPHERYS, Lehi, UT (US); Jonathan LANCAR, Fremont, CA (US)

(21) Appl. No.: 18/530,619

(22) Filed: Dec. 6, 2023

(51) Int. Cl. G06Q 20/36; G06Q 20/02; G06Q 20/06; G06Q 20/40

(52) U.S. Cl. CPC G06Q 20/3674; G06Q 20/02; G06Q 20/0655; G06Q 20/409

(57) ABSTRACT

Methods and systems are provided for redeeming entitlements deployed on blockchain. In embodiments described herein, a token associated with a blockchain wallet of a user is accessed from a blockchain. A plurality of parameters of an entitlement associated with the token are determined. The plurality of parameters include a representation of customer data of the user, a representation of the entitlement and an indication of an application for redeeming the entitlement. Responsive to verifying the blockchain wallet of the user based on the customer data, the application executes the redemption of the entitlement.

### BACKGROUND

Blockchain technologies offer businesses and customers an open and transparent framework for exchanging value in the form of fungible and non-fungible tokens (“NFTs”). However, while native blockchain technologies offer many advantages for engagement of the customer with the business, native blockchain technologies lack features that businesses require to continuously and personally engage with customers at scale.

### SUMMARY

Various aspects of the technology described herein are generally directed to systems, methods, and computer storage media for, among other things, redeeming entitlements deployed on blockchain. In this regard, embodiments described herein facilitate redeeming entitlements deployed on blockchain by accessing, from a blockchain, a fungible and/or non-fungible token associated with a blockchain wallet of a user (e.g. a customer or potential customer of the business). The fungible and/or non-fungible token includes corresponding parameters of the entitlement stored in connection to the token. For example, the parameters of the entitlement can include a representation of the entitlement, an indication of an application for redeeming the entitlement, customer data of the user, conditions for redeeming the entitlement, and/or any data regarding the entitlement. Responsive to verifying the blockchain wallet of the user based on the customer data stored in the parameters and/or verifying conditions stored in the parameters for redeeming the entitlement, the entitlement is provided to the application for redeeming the entitlement (e.g., any web services or applications for providing entitlements, such as a third-party e-commerce application or website, point-of-sale application or website, or an event entry management application or website, a travel application or website, and/or any other connected hardware devices to the applications and/or websites) to cause the application to redeem the entitlement. In this regard, the entitlement can be provided to the application to redeem the entitlement as instructions formatted for the technology that is distributing the entitlement.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of a model implemented for redeeming entitlements deployed on blockchain, in accordance with embodiments of the present disclosure.

FIG. 4 is a process flow showing a method for redeeming entitlements deployed on blockchain, in accordance with embodiments of the present disclosure.

FIG. 5 is a process flow showing a method for redeeming entitlements deployed on blockchain, in accordance with embodiments of the present disclosure.

FIG. 6 is a process flow showing a method for redeeming entitlements deployed on blockchain, in accordance with embodiments of the present disclosure.

FIG. 7 is a block diagram of an example computing device in which embodiments of the present disclosure can be employed.

### DETAILED DESCRIPTION

Various terms are used throughout the description of embodiments provided herein. A brief overview of such terms and phrases is provided here for ease of understanding, but more details of these terms and phrases is provided throughout.

“Blockchain” refers to a decentralized digital ledger technology that records transactions across multiple computers in a secure and transparent manner. Blockchain uses cryptographic techniques to ensure the immutability and integrity of data. Blockchain typically operates in a trustless transaction environment, which refers to a system or network where participants can engage in transactions or exchanges without requiring a central authority. Instead, trust is established through cryptographic protocols and consensus mechanisms. Examples of applications utilizing blockchain include cryptocurrencies, smart contracts, etc. A public blockchain is a type of blockchain network that is open and accessible to anyone and without requiring approval to participate, whereas a private blockchain is a type of blockchain network where access and permissions to participate are restricted. A “blockchain virtual machine” refers to a virtual execution environment that operates within a blockchain network and allows developers to deploy and execute smart contracts on the blockchain platform.

A “smart contract” refers to a digital contract with the terms and/or conditions of an agreement directly written into code, which is referred to as “smart contract code.” A smart contract automatically enforces and executes the agreed-upon actions when certain conditions are met, without the need for a central authority or an intermediary, through the smart contract code of the smart contract. Smart contracts are often used on blockchain platforms to ensure transparency, security, and automation in various processes, such as financial transactions, digital identity verification, etc. Examples of languages for drafting smart contracts include solidity, teal, etc.

A “fungible token” refers to a type of digital asset that represents ownership or value and is interchangeable with other fungible tokens of the same type. In this regard, each unit of a fungible token is identical and can be exchanged on a one-to-one basis, similar to how physical currency works. A “non-fungible token (“NFT”)” refers to a unique digital asset that represents ownership or proof of authenticity of a specific item or specific piece of content. Unlike fungible tokens, each NFT is distinct and cannot be exchanged on a one-to-one basis with other tokens.

“Entitlements” refers to rights, benefits, and/or privileges provided to a customer based on their purchase or relationship with a business. Entitlements can vary based on the type of business, industry, and the specific offerings provided to customers by the business. For example, depending on the product or service acquired by the customer, entitlements can include access to certain features, services, support, upgrades, or discounts. Additional examples of entitlements include: (1) software entitlements that may provide access to specific software features based on the type of software license; (2) support entitlements that may provide priority or extended customer support; (3) membership entitlements that may provide exclusive access to members-only content; (4) subscription entitlements that may provide access to premium content; (5) upgrade entitlements that may provide eligibility for a free upgrade of a product; (6) discount entitlements that may provide discounts on products or services; (7) warranty entitlements that may provide coverage for repairs or replacements for a period of time; (8) service entitlements that may provide access to certain features, like priority boarding for airlines; (9) refund entitlements that may provide the ability to request refunds or returns; (10) customization entitlements that may provide options to customize products or services to suit individual preferences; and/or etc.

A “personalized entitlement” refers to a type of entitlement that is uniquely generated for a specific customer based on the customer data for the specific customer. In some embodiments, personalized entitlements can be dynamically assembled in batches and can include personalized parameters for the specific customer. In some embodiments, personalized entitlements can be dynamically assembled during real-time interactions with the customer and can include personalized parameters for the specific customer. In this regard, a business can define a personalized entitlement for a specific customer by defining variables, such as the parameter types, parameter data sources and corresponding entitlement, which are written into a personalized smart contract for the specific customer and deployed on a blockchain virtual machine. An example of a personalized entitlement can include a discount token on merchandise with a personalized discount rate, list of eligible products, and validity for a specific customer.

“Customer data” refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, and nearly any other source of data that may be used to identify the customer.

A “customer journey” refers to a series or sequence of interactions between a customer and a business over time. Journeys occur over various channels, such as e-mail, phone calls/texting, social media, websites, physical locations, and any channel in which a customer and business interact. A customer journey can include a set of one or more events, conditions, and/or corresponding actions (e.g., responses). To this end, a customer journey can include a sequence of events, conditions, and/or actions (e.g., responses) through which customers may traverse. Customer journeys can be designed by users, such as marketers or businesses, to meet the goals of the business, such as to obtain new customers, develop leads, increase conversions, and increase loyalty. Customer journeys can be designed with various paths based on customer interactions, behavior, preferences, customer demographics, etc.

### Overview

Blockchain technologies offer businesses and customers an open and transparent framework for exchanging value in the form of fungible and non-fungible tokens (“NFTs”). However, while native blockchain technologies offer many advantages for engagement of the customer with the business, native blockchain technologies lack features that businesses require to continuously and personally engage with customers at scale. For example, blockchain powered technologies, such as collectible NFTs, etc., may have a unique asset or content associated with a token, but the uniqueness is limited to the asset or content and does not change based on the customer purchasing the collectible NFT.

Currently, in order for the business to offer blockchain-based offerings (e.g., fungible and/or non-fungible tokens related to a business's offerings), a business must manually design, program and test, or hire a programmer to manually design, program and test, the blockchain-based offerings. For any customizations to the blockchain-based offerings, blockchain-based offerings must be manually designed for the specific scenario. In this regard, the process of customizing blockchain-based offerings is a manually intensive process requiring the manual designing, programming, and testing before deploying each customized blockchain-based offerings.

Accordingly, unnecessary computing resources are utilized by businesses to redeem blockchain-based tokens offered by a business, such as fungible or non-fungible tokens, in conventional implementations. For example, computing and network resources are unnecessarily consumed to facilitate the manually intensive process in order to redeem customized blockchain-based tokens offered by a business. For instance, computer input/output operations are unnecessarily increased in order for a business to manually analyze each customized blockchain-based token in a customer's blockchain wallet in order to determine whether the customized blockchain-based token is redeemable and/or how to redeem the customized blockchain-based token. In this regard, the manual analysis of each customized blockchain-based token to confirm the blockchain-based token was offered by the business, the manual analysis to confirm the specific benefits associated with the customized blockchain-based token, and the manual process of providing the benefits associated with the customized blockchain-based token is computationally expensive. Further, when information related to redeeming the customized blockchain-based token is located in a disk array, there is unnecessary wear placed on the read/write head of the disk of the disk array each time the information is accessed. Even further, the processing of operations for the analysis of customized blockchain-based tokens from a customer's wallet in order to redeem customized blockchain-based tokens offered by a business decreases the throughput for a network, increases the network latency, and increases packet generation costs when the information is located over a network. In this regard, usage of network resources is multiplied due to the amount of information pertaining to the redeeming of customized blockchain-based tokens that must be manually accessed and manually analyzed in order to manually provide benefits associated with the customized blockchain-based tokens.

As such, embodiments of the present disclosure are directed to redeeming entitlements deployed on blockchain in an efficient and effective manner. In this regard, blockchain-based entitlements can be efficiently and effectively deployed on blockchain, and the blockchain-based entitlements can be redeemed through any technology that is distributing the corresponding entitlement.

Generally, and at a high level, embodiments described herein facilitate redeeming entitlements deployed on blockchain by accessing, from a blockchain, a fungible and/or non-fungible token associated with a blockchain wallet of a user (e.g. a customer or potential customer of the business). The fungible and/or non-fungible token includes corresponding parameters of the entitlement stored in connection to the token. For example, the parameters of the entitlement can include a representation of the entitlement, an indication of an application for redeeming the entitlement, customer data of the user, conditions for redeeming the entitlement, and/or any data regarding the entitlement. Responsive to verifying the blockchain wallet of the user based on the customer data stored in the parameters and/or verifying conditions stored in the parameters for redeeming the entitlement, the entitlement is provided to the application for redeeming the entitlement (e.g., any web services or applications for providing entitlements, such as a third-party e-commerce application or website, point-of-sale application or website, or an event entry management application or website, a travel application or website, and/or any other connected hardware devices to the applications and/or websites) to cause the application to redeem the entitlement. In this regard, the entitlement can be provided to the application to redeem the entitlement as instructions formatted for the technology that is distributing the entitlement.

In operation, entitlements can be designed and/or deployed by a business in order to record the entitlements on blockchain (e.g., public blockchain or private blockchain) following certain events, such as interactions with customers. For example, a business user (e.g., a user associated with the business) can define various types of entitlements, including parameters related to the entitlements, services, subscriptions, etc., that the business offers to other users, such as customers or potential customers of the business (e.g., as part of their commercial product and service offerings, promotional and loyalty programs, etc.). In some embodiments, the business user defines how the customers access or redeem entitlements (e.g., access subscription content, enter a venue, return a product, access customer support, etc.). For example, a business user of an airline can define parameters of an entitlement that allows a customer to book a flight and hotel following a flight cancellation and define parameters related to the applications, websites, airlines, hotels, etc. at which the entitlement can be redeemed.

Following an event triggering the offering of the entitlement, the entitlement can automatically be modified (e.g., customized/personalized) based on the customer data of the customer and recorded on blockchain (e.g., public blockchain or private blockchain). The blockchain-based entitlements can be encoded in fungible and/or non-fungible tokens and delivered to a blockchain wallet belonging to the customer. In this regard, a business can offer personalized, blockchain-based products and services to qualifying customers in response to real-time signals from customer data or scheduled events. For example, a change in customer data of a customer may trigger the offering of an entitlement to be recorded on blockchain. As a more specific example, a business deploys an entitlement to deliver a blockchain-based entitlement as a reward to each customer who checks in at one of the retail locations of the business. Following the customer data being updated (e.g., changed) to indicate that the customer checked-in at one of the retail locations of the business, the offering of the blockchain-based entitlement as a reward with the customer data of the customer can be triggered. In some embodiments, blockchain-based entitlements deployed by a business can be personalized and offered to customers in real-time or near real-time. In some embodiments, asynchronous transactions are performed by pushing offers to customers at scheduled intervals or upon a qualification that is not associated with a real-time customer interaction.

In order to redeem the blockchain-based entitlement through an application (e.g., any web services or applications for providing entitlements, such as a third-party e-commerce application or website, point-of-sale application or website, an event entry management application or website, a travel application or website, and/or any other connected hardware devices of the websites and/or applications), the fungible and/or non-fungible token (e.g., token) associated with a blockchain wallet of a user (e.g. a customer or potential customer of the business) is accessed from a blockchain. In some embodiments, a request for entitlement redemption is received from a device executing the application for redeeming the entitlement and/or a device of the user. For example, assume a customer buys a cloud-based, antivirus subscription and needs to access online customer support. The customer receives a blockchain-based entitlement with parameters designating the customer's level of online support access. The customer clicks on the support tab of the retailer's web site and connects their blockchain wallet to receive immediate access to the contractually guaranteed level of customer support. When the customer clicks on the support tab, the retailer's website communicates with a blockchain-based entitlement customer experience management system and the system automatically verifies the blockchain token and transmits the customer's designated level of online support access to the customer support software to provide the designated level of customer support.

In some embodiments, the request for entitlement redemption includes the public identifier of the blockchain wallet (e.g., the blockchain wallet ID). For example, the user's device (e.g., the customer's device) may communicate the blockchain wallet ID to the device executing the application for redeeming the entitlement via Hypertext Transfer Protocol (HTTP), near-field communication (NFC), Bluetooth, a quick-response (QR) Code, and/or the like. In some embodiments, the device of the user and/or the blockchain wallet ID may be used to authenticate the user in order to redeem the blockchain-based entitlement. For example, assume a transportation entity, such as a railway, sells transportation packages on its system of trams and gondolas through affiliate retail partners. The affiliate retail partners can create their own packages and pricing but when customers buy a transportation package from any retailer, the customer receives a non-fungible token, which includes parameters corresponding to the transportation package that customer purchased. At the point of service, the customer taps or scans their authenticated mobile device using NFC, Bluetooth, or a QR code into software and/or hardware implementing the gating system to utilize a tram or gondola. The software and/or hardware implementing the gating system communicates customer data for the user, such as the data identifying the customer's authenticated device and/or the customer's blockchain wallet ID as received from the customer's authenticated mobile device, to a blockchain-based entitlement customer experience management system. The system automatically verifies the blockchain token associated with the customer's blockchain wallet ID and communicates to the software and/or hardware implementing the gating system to allow or not allow the customer to enter.

In some embodiments, the token associated with the blockchain wallet of the user is accessed at a scheduled interval in order to cause the application for redeeming the entitlement to redeem the entitlement asynchronously, such as a part of a customer journey. For example, e-commerce software automatically sends a request to a blockchain-based entitlement customer experience management system to determine whether a customer is eligible for a free item based on customer data, such as shopping history over a previous timeframe. If the customer data indicates that the customer is eligible for the free item, the system communicates the customer's entitlement qualification status to the e-commerce software. The e-commerce software can then implement sending the customer the free item.

Following accessing the token associated with a blockchain wallet of a user, parameters of an entitlement associated with the token are determined. The parameters of each entitlement can include a representation of any number of rights, benefits, and/or privileges of the entitlement, an indication of an application for redeeming the entitlement, an indication of the format utilized by the application to redeem the entitlement, customer data of the user, conditions for redeeming the entitlement, and/or any data regarding the entitlement. In some embodiments, a representation of the plurality of parameters of the entitlement is stored in the token on blockchain. In some embodiments, a representation of a portion of the plurality of parameters of the entitlement is stored in the token and a representation of the remaining plurality of parameters of the entitlement is stored in a database or retrieved from data sources (e.g., location of the user's device or device implementing the application for redeeming the entitlement). For example, certain customer data of the user, which can be used to verify certain conditions of the entitlement, such as the user's purchase history or the user's customer segment, may be stored in a database.

In some embodiments, the customer data stored in the parameters of the entitlement includes the blockchain wallet ID in order to verify the blockchain wallet ID communicated by the user's device (e.g., customer's device) matches the blockchain wallet ID stored in the parameters. In some embodiments, the parameters may include conditions for redeeming the entitlement, such as timeframe for redeeming the entitlement, a location for redeeming the entitlement, identity verification for redeeming the entitlement, and/or customer data conditions, such as customer profile, customer segment, purchase history, and/or any conditions for redeeming the entitlement. For example, with respect to a timeframe for redeeming the entitlement, a customer who belongs to a retailer's loyalty member program may possess a blockchain-based entitlement corresponding to a discount token with a personalized discount rate for the customer. Parameters of the blockchain-based entitlement, as designated by the retailer, may include conditions providing that the discount is only valid during the timeframe of the retailer's end-of-year sale, only valid on weekends, and/or the like. With respect to a location for redeeming the entitlement, as an example, parameters of the blockchain-based entitlement (e.g., as designated by the retailer) may include conditions defining specific locations at which the entitlement can be redeemed, such as in a store or at a location of an event. In this regard, the conditions can require a customer to authenticate via a web service or application that has access to location information in order to redeem the entitlement of the blockchain-based entitlement. With respect to identifying verification for redeeming the entitlement, as an example, parameters of the blockchain-based entitlement (e.g., as designated by the retailer) may include conditions requiring a form of identity verification in addition to authenticating the blockchain wallet. For example, the conditions can require a customer to utilize identity verification applications, such as a first or third-party identification services and/or services on the consumer's device (e.g., as biometrics), in order to redeem the entitlement of the blockchain-based entitlement.

As a more specific example, an ice cream store provides tokens corresponding to blockchain-based entitlements to customers who attended a soccer match. Parameters of the blockchain-based entitlement, as designated by the ice cream store, include conditions (e.g., parameters stored in the token on a blockchain) that if a team from the soccer game scores three goals in the match, the customers are entitled to a free soft serve cone at the location of the ice cream store that same day. After a qualifying match in which three goals were scored, a customer visits the location of the ice cream store and tap their mobile device at the Point-of-Sale (POS) terminal using NFC mobile technology. The POS terminal communicates identification information using then customer's mobile device, such as the device ID or blockchain wallet ID, to a blockchain-based entitlement customer experience management system. The system automatically verifies a blockchain token associated with the customer's mobile device or blockchain wallet ID. The system automatically verifies the qualifying conditions, including the location of the ice cream store, the day, and the number of goals in the match through one or more data sources. The system then communicates the entitlement to the POS system in order for the POS system to provide the free soft serve cone.

Responsive to verifying the identification of the blockchain wallet of the user based on the customer data stored in the parameters and/or verifying conditions stored in the parameters for redeeming the entitlement, the entitlement is provided to the application for redeeming the entitlement to cause the application to redeem the entitlement. In this regard, the entitlement can be provided to the application to redeem the entitlement as instructions formatted for the technology that is distributing the entitlement. For example, parameters of blockchain-based entitlement may require the system to communicate may include a yes or no instruction to a hardware scanner (e.g., a touchless scanning device) for entry to a venue or event, instructions including a personalized discount rate to the commerce software powering a storefront, and/or the like.

In some embodiments, the entitlement redemption parameters may include instructions that are specific to each customer, such as a personalized discount rate based on a personalized entitlement stored in the token. For example, a customer who belongs to the membership program of a local gas retailer taps their phone on the payment device for a gas terminal while authenticated with their blockchain wallet. The application implementing the payment device for the gas terminal communicates the blockchain wallet ID to a blockchain-based entitlement customer experience management system. The system accesses the blockchain-based entitlement associated with the blockchain wallet ID, determines the parameters of the blockchain-based entitlement, verifies the blockchain wallet ID of the customer based on the parameters, and communicates the customer's personal reward discount rate to the application implementing the payment device for the gas terminal. The application implementing the payment device for the gas terminal then applies the customer's personal reward discount rate at the pump.

In some embodiments, after the entitlement is provided to the application for redeeming the entitlement, a redemption qualification status indicating that the customer is qualified to redeem the entitlement can be stored by the application for redeeming the entitlement for a designated period of time after which the status must be re-verified. In some embodiments, parameters of the blockchain-based entitlement, as designated by the business implementing the blockchain-based entitlement, can include entitlement scopes, such as whether the entitlement of the blockchain-based entitlement is one-time use (e.g., a single use coupon) or recurring (e.g., 10% off all purchases). In this regard, the blockchain-based entitlement customer experience management system can record each redemption in the blockchain-based entitlement on blockchain and update the customer's qualification status. In some embodiments, the tokens corresponding to the blockchain-based entitlements are burned (e.g., deleted) when entitlements expire. In some embodiments, the tokens corresponding to the blockchain-based entitlements remain as historical records when entitlement expire. In some embodiments, business users can use the blockchain-based entitlement customer experience management system to designate how much information about the entitlements is stored in the blockchain token (e.g., conditions, customer data, any data related to the entitlement) and how much information is stored privately (e.g., on a private blockchain or in a database that is not on a public or private blockchain) within the blockchain-based entitlement customer experience management system.

Advantageously, efficiencies of computing and network resources can be enhanced using implementations described herein. In particular, the automated redeeming of blockchain-based entitlements provides for a more efficient use of computing resources (e.g., higher throughput and reduced latency for a network, less packet generation costs, etc.) than conventional methods requiring the manual analysis of each customized blockchain-based token to confirm the blockchain-based token was offered by the business, the manual analysis to confirm the specific benefits associated with the customized blockchain-based token, and the manual process of providing the benefits associated with the customized blockchain-based token. The technology described herein results in less operations over a computer network for the analysis of customized blockchain-based tokens from a customer's wallet in order to redeem customized blockchain-based tokens offered by a business, which results in higher throughput, reduced latency and less packet generation costs as fewer packets are sent over a network. Therefore, the technology described herein conserves network resources.

Overview of Exemplary Environments for Redeeming Entitlements Deployed on Blockchain

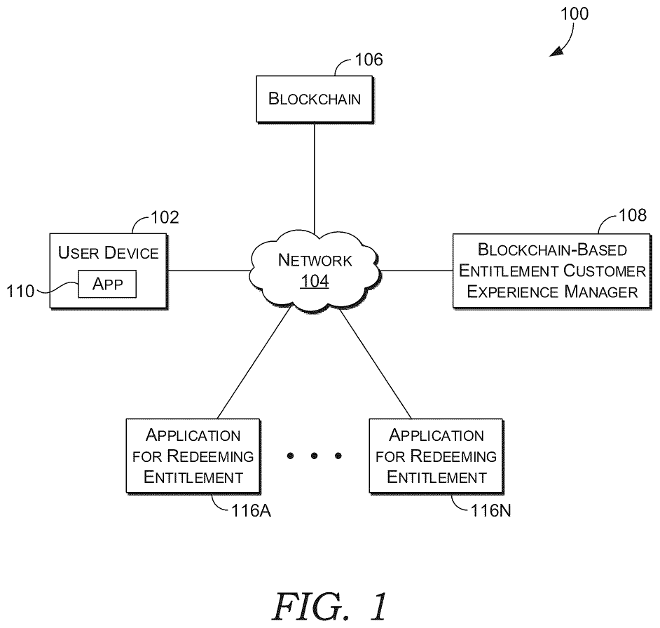

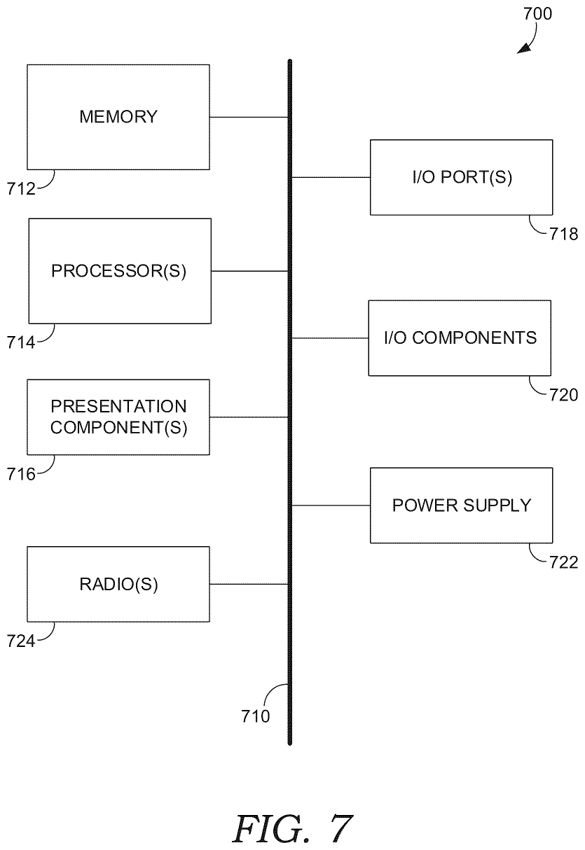

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that operating environment 100 shown in FIG. 1 is an example of one suitable operating environment. Among other components not shown, operating environment 100 includes a user device 102, network 104, blockchain 106, application for redeeming entitlement 116A-N, and blockchain-based entitlement customer experience manager 108. Each of the components shown in FIG. 1 can be implemented via any type of computing device, such as one or more of computing device 700 described in connection to FIG. 7, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., customers receiving blockchain-based entitlements or a business offering blockchain-based entitlements to customers of the business). For example, in some implementations, such devices are the type of computing device described in relation to FIG. 7. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

User device 102 can be a client device on a client-side of operating environment 100, while blockchain-based entitlement customer experience manager 108 can be on a server-side of operating environment 100. Blockchain-based entitlement customer experience manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or blockchain-based entitlement customer experience manager 108 to remain as separate entities.

Application 110 operating on user device 102 can generally be any application capable of facilitating the exchange of information between the user device(s) and the blockchain-based entitlement customer experience manager 108 in deploying the blockchain-based entitlement by a business user, redeeming entitlements of blockchain-based entitlements by a customer, verifying the user device to redeem the entitlements, and/or communicating the blockchain wallet of the user to the applications for redeeming entitlement 116A-N. In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly.

In operation, blockchain-based entitlement customer experience manager 108 facilitates the design and deployment of entitlements in order to record the entitlements on blockchain 106 (e.g., public blockchain or private blockchain) following certain events, such as interactions with customers. For example, blockchain-based entitlement customer experience manager 108 facilitates a business user (e.g., a user associated with the business) to be able to define various types of entitlements, including parameters related to the rights, benefits, and/or privileges of the entitlements, services, subscriptions, and/or etc., that the business offers to other users, such as customers or potential customers of the business (e.g., as part of their commercial product and service offerings, promotional and loyalty programs, etc.). In some embodiments, blockchain-based entitlement customer experience manager 108 facilitates the business user to be able to define how the customers access or redeem entitlements (e.g., access subscription content, enter a venue, return a product, access customer support, etc.).

Following an event triggering the offering of the entitlement, blockchain-based entitlement customer experience manager 108 facilitates automatically modifying (e.g., customizing/personalizing) the entitlement based on the customer data of the customer and recording on blockchain 106 (e.g., public blockchain or private blockchain). Blockchain-based entitlement customer experience manager 108 facilitates encoding the blockchain-based entitlements in fungible and/or non-fungible tokens and delivering to a blockchain wallet belonging to the customer. In some embodiments, blockchain-based entitlement customer experience manager 108 facilitates deploying blockchain-based entitlements to customers in real-time or near real-time. In some embodiments, blockchain-based entitlement customer experience manager 108 facilitates performing asynchronous transactions by pushing offers to customers at scheduled intervals or upon a qualification that is not associated with a real-time customer interaction.

In order to redeem the blockchain-based entitlement through an application for redeeming entitlement 116A-N (e.g., any web services or applications for providing entitlements, such as a third-party e-commerce application or website, point-of-sale application or website, an event entry management application or website, a travel application or website, and/or any other connected hardware devices of the websites and/or applications), the fungible and/or non-fungible token (e.g., token) associated with a blockchain wallet of a user (e.g. a customer or potential customer of the business) is accessed from a blockchain 106 by blockchain-based entitlement customer experience manager 108. In some embodiments, a request for entitlement redemption is received from user device 102, such as a device executing the application for redeeming entitlement 116A-N and/or a user device 102.

In some embodiments, the request for entitlement redemption includes the public identifier of the blockchain wallet (e.g., the blockchain wallet ID). For example, the user device 102 (e.g., the customer's device) may communicate the blockchain wallet ID via application 110 to the device executing the application for redeeming entitlement 116A-N via Hypertext Transfer Protocol (HTTP), near-field communication (NFC), Bluetooth, a quick-response (QR) Code, and/or the like. In some embodiments, the user device 102 and/or the blockchain wallet ID may be used to authenticate the user in order to redeem the blockchain-based entitlement by blockchain-based entitlement customer experience manager 108.

In some embodiments, the token associated with the blockchain wallet of the user is accessed at a scheduled interval by blockchain-based entitlement customer experience manager 108 in order to cause the application for redeeming entitlement 116A-N to redeem the entitlement asynchronously, such as a part of a customer journey.

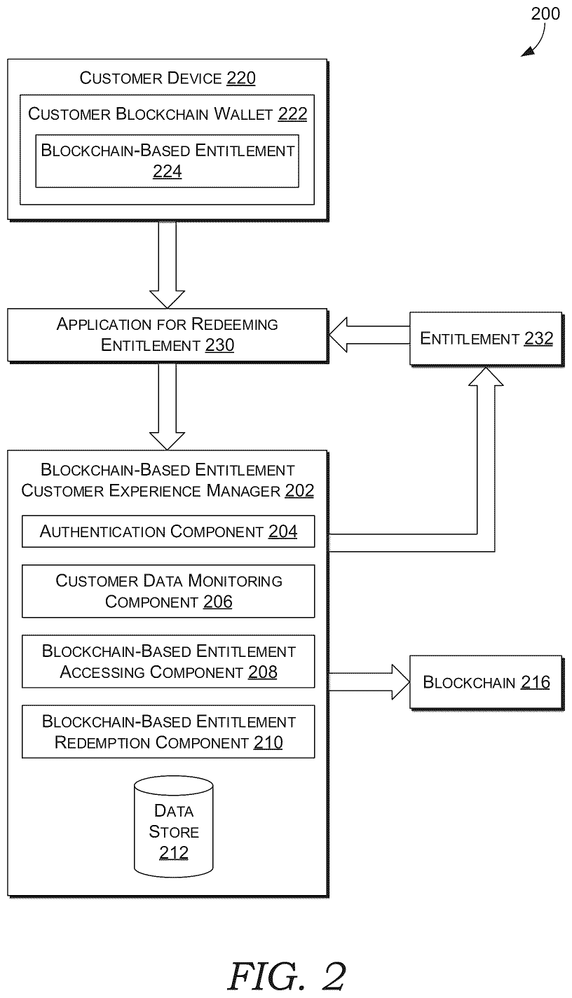

Following accessing the token, from blockchain 106, associated with a blockchain wallet of a user (e.g., via application 110 of user device 102), parameters of an entitlement associated with the token are determined by blockchain-based entitlement customer experience manager 108. The parameters of the entitlement can include a representation of any number of rights, benefits and/or privileges of the entitlement, an indication of an application for redeeming the entitlement, an indication of the format utilized by the application to redeem the entitlement, customer data of the user, conditions for redeeming the entitlement, and/or any data regarding the entitlement. In some embodiments, a representation of the plurality of parameters of the entitlement is stored in the token on blockchain 106. In some embodiments, a representation of a portion of the plurality of parameters of the entitlement is stored in the token on blockchain 106 and a representation of the remaining plurality of parameters of the entitlement is stored in a database (e.g., data store 212 of FIG. 2) or retrieved from data sources (e.g., location of the user's device or device implementing the application for redeeming entitlement 116A-N) by blockchain-based entitlement customer experience manager 108.

In some embodiments, the customer data stored in the parameters of the entitlement includes the blockchain wallet ID in order to verify the blockchain wallet ID communicated by the user device 102 (e.g., customer's device) matches the blockchain wallet ID stored in the parameters by blockchain-based entitlement customer experience manager 108. In some embodiments, the parameters may include conditions for redeeming the entitlement, such as timeframe for redeeming the entitlement, a location for redeeming the entitlement, identity verification for redeeming the entitlement, and/or customer data conditions, such as customer profile, customer segment, purchase history, and/or any conditions for redeeming the entitlement.

Responsive to verifying the identification of the blockchain wallet of the user based on the customer data stored in the parameters and/or verifying conditions stored in the parameters for redeeming the entitlement by blockchain-based entitlement customer experience manager 108, blockchain-based entitlement customer experience manager 108 provides the entitlement to the application 116A-N to cause the application 116A-N to redeem the entitlement. In this regard, the entitlement can be provided to the application 116A-N to redeem the entitlement as instructions formatted for the technology that is distributing the entitlement. For example, parameters of blockchain-based entitlement, may require blockchain-based entitlement customer experience manager 108 to communicate a yes or no instruction to a hardware scanner (e.g., a touchless scanning device) for entry to a venue or event in communication with an application 116A-N; instructions including a personalized discount rate to the commerce software powering a storefront (e.g., an application 116A-N), and/or the like.

In some embodiments, the entitlement redemption parameters determined by blockchain-based entitlement customer experience manager 108 may include instructions that are specific to each customer, such as a personalized discount rate based on a personalized entitlement stored in the token. In some embodiments, after the entitlement is provided to the application 116A-N, a redemption qualification status indicating that the customer is qualified to redeem the entitlement can be stored by the application 116A-N for a designated period of time after which the status must be re-verified. In some embodiments, parameters of the blockchain-based entitlement, as designated by the business implementing the blockchain-based entitlement through blockchain-based entitlement customer experience manager 108, can include entitlement scopes, such as whether the entitlement of the blockchain-based entitlement is one-time use (e.g., a single use coupon) or recurring (e.g., 10% off all purchases). In this regard, blockchain-based entitlement customer experience manager 108 can record each redemption in the blockchain-based entitlement on blockchain 106 and update the customer's qualification status. In some embodiments, the tokens corresponding to the blockchain-based entitlements are burned (e.g., deleted) by blockchain-based entitlement customer experience manager 108 when entitlements expire. In some embodiments, the tokens corresponding to the blockchain-based entitlements remain as historical records on blockchain 106 when entitlement expire. In some embodiments, business users can use blockchain-based entitlement customer experience manager 108 to designate how much information about the entitlements is stored in the blockchain token (e.g., conditions, customer data, any data related to the entitlement) on blockchain 106 and how much information is stored privately (e.g., on a private blockchain or in a database that is not on a public or private blockchain) in communication with blockchain-based entitlement customer experience manager 108.

Generally, the blockchain-based entitlement customer experience manager 108 receives data from any number of devices. As such, the blockchain-based entitlement customer experience manager 108 can identify and/or collect data from various user devices, such as user device 102, blockchain 106, applications for redeeming entitlement 116A-N, and any other data sources (e.g., data store 212 of FIG. 2).

Customer data can be initially collected at remote locations or systems and transmitted to a data store (e.g., data store 212 of FIG. 2) for access by blockchain-based entitlement customer experience manager 108 and may include servers, data stores, or other components, including computing devices operated by businesses (e.g., for customer data, etc.), public blockchain, private blockchain, etc. Customer data can be obtained at a data source periodically or in an ongoing manner (or at any time) and provided to the blockchain-based entitlement customer experience manager 108 to facilitate redeeming entitlements deployed on blockchain.

Blockchain-based entitlement customer experience manager 108 can be or include a server, including one or more processors, and one or more computer-readable media. The computer-readable media includes computer-readable instructions executable by the one or more processors. The instructions can optionally implement one or more components of blockchain-based entitlement customer experience manager 108, described in additional detail below with respect to blockchain-based entitlement customer experience manager 202 of FIG. 2.

At a high level, blockchain-based entitlement customer experience manager 108 performs various functionality to facilitate efficient and effective redeeming of entitlements deployed on blockchain. For cloud-based implementations, the instructions on blockchain-based entitlement customer experience manager 108 can implement one or more components, and application 110 can be utilized by a user to interface with the functionality implemented on blockchain-based entitlement customer experience manager 108. In some cases, application 110 comprises a web browser. In other cases, blockchain-based entitlement customer experience manager 108 may not be required. For example, the components of blockchain-based entitlement customer experience manager 108 may be implemented completely on a user device, such as user device 102. In this case, blockchain-based entitlement customer experience manager 108 may be embodied at least partially by the instructions corresponding to application 110.

Thus, it should be appreciated that blockchain-based entitlement customer experience manager 108 may be provided via multiple devices arranged in a distributed environment that collectively provide the functionality described herein. Additionally, other components not shown may also be included within the distributed environment. In addition, or instead, blockchain-based entitlement customer experience manager 108 can be integrated, at least partially, into a user device, such as user device 102. Furthermore, blockchain-based entitlement customer experience manager 108 may at least partially be embodied as a cloud computing service.

Referring to FIG. 2, aspects of an illustrative blockchain-based entitlement customer experience management system are shown, in accordance with various embodiments of the present disclosure. As shown in FIG. 2, blockchain-based entitlement customer experience manager 202 includes an authentication component 204, a customer data monitoring component 206, a blockchain-based entitlement accessing component 208, a blockchain-based entitlement redemption component 210, and a data store 212. The foregoing components of blockchain-based entitlement customer experience manager 202 can be implemented, for example, in operating environment 100 of FIG. 1. In particular, those components may be integrated into any suitable combination of user devices 102 and/or blockchain-based entitlement customer experience manager 108.

Data store 210 can store computer instructions (e.g., software program instructions, routines, or services), data, such as customer data, data related to entitlements, etc., and/or components/models used in embodiments described herein. In some implementations, data store 210 stores information or data received or generated via the various components of blockchain-based entitlement customer experience manager 202 and provides the various components with access to that information or data, as needed. Although depicted as one component, data store 210 may be embodied as one or more data stores. Further, the information in data store 210 may be distributed in any suitable manner across one or more data stores for storage (which may be hosted externally).

In embodiments, data stored in data store 210 includes customer data, data related to entitlements, such as definitions, parameters, templates, blockchain-based entitlements, and/or the like. In some cases, blockchain-based entitlement customer experience manager 202, or components associated therewith, can obtain data from client devices (e.g., customer data, data generated by devices of the business, etc.). In some cases, data can be received from one or more data stores in the cloud, or data generated by the blockchain-based entitlement customer experience manager 202.

The authentication component 204 is generally configured to authenticate a customer, such as by a customer device 220 or a blockchain wallet ID of a customer blockchain wallet 222. The authentication component 204 can include rules, conditions, associations, models, algorithms, or the like to authenticate a customer. For example, authentication component 204 may comprise natural language processing techniques, statistical model, fuzzy logic, neural network, finite state machine, support vector machine, logistic regression, clustering, or machine-learning techniques, similar statistical classification processes, or combinations of these to authenticate a customer. In some embodiments, authentication component 204 is an application (e.g., application 110 of FIG. 1) on the customer device. In some embodiments, authentication component 204 is a component of the application 230 for redeeming entitlement or in communication with application 230 for redeeming entitlement.

The customer data monitoring component 206 is generally configured to monitor customer data for events triggering deployed entitlements and/or conditions for redeeming blockchain-based entitlements. The customer data monitoring component 206 can include rules, conditions, associations, models, algorithms, or the like to monitor customer data. For example, customer data monitoring component 206 may comprise natural language processing techniques, statistical model, fuzzy logic, neural network, finite state machine, support vector machine, logistic regression, clustering, or machine-learning techniques, similar statistical classification processes, or combinations of these to monitor customer data.

The blockchain-based entitlement accessing component 208 is generally configured to access blockchain-based entitlements (e.g., from a blockchain 216). The blockchain-based entitlement accessing component 208 can include rules, conditions, associations, models, algorithms, or the like to access blockchain-based entitlements. The blockchain-based entitlement redemption component 210 is generally configured to redeem entitlements of blockchain-based entitlements. The blockchain-based entitlement redemption component 210 can include rules, conditions, associations, models, algorithms, or the like to redeem entitlements of blockchain-based entitlements.

In operation, in order to redeem the entitlement 232 of blockchain-based entitlement 224 through an application 230 (e.g., any web services or applications for providing entitlements, such as a third-party e-commerce application or website, point-of-sale application or website, an event entry management application or website, a travel application or website, and/or any other connected hardware devices), the fungible and/or non-fungible token (e.g., token) of a blockchain-based entitlement 224 associated with a blockchain wallet 222 of a user (e.g. a customer or potential customer of the business) is accessed from a blockchain 216 by blockchain-based entitlement accessing component 208. In some embodiments, a request for entitlement redemption is received from a device, such as a device executing the application 230 and/or a customer device 220.

In some embodiments, the request for entitlement redemption includes the public identifier of the blockchain wallet 222 (e.g., the blockchain wallet ID). For example, the customer device 220 (e.g., the customer's device) may communicate the blockchain wallet ID to the device executing the application 230 via Hypertext Transfer Protocol (HTTP), near-field communication (NFC), Bluetooth, a quick-response (QR) Code, and/or the like. In some embodiments, the user device 220 and/or the blockchain wallet ID of the customer blockchain wallet 222 may be used to authenticate the user by authentication component 204 in order to redeem the entitlement 232 designated in the blockchain-based entitlement.

In some embodiments, the token associated with the blockchain wallet of the user is accessed at a scheduled interval by blockchain-based entitlement accessing component 208 in order to cause the application 230 to redeem the entitlement 232 asynchronously, such as a part of a customer journey.

Following accessing the blockchain-based entitlement 224 associated with a customer blockchain wallet 222 of a customer by blockchain-based entitlement accessing component 208, parameters of an entitlement associated with the blockchain-based entitlement 224 are determined by blockchain-based entitlement redemption component 210. The parameters of the blockchain-based entitlement 224 can include a representation of any number of rights, benefits and/or privileges of the entitlement 232, an indication of an application 230, an indication of the format utilized by the application 230, customer data of the user, conditions for redeeming the entitlement, and/or any data regarding the entitlement. In some embodiments, a representation of the plurality of parameters of the entitlement is stored in the token on blockchain 216. In some embodiments, a representation of a portion of the plurality of parameters of the entitlement is stored in the token on blockchain 216 and a representation of the remaining plurality of parameters of the entitlement is stored in data store 212 or retrieved from data sources (e.g., location of the user's device or device implementing the application for redeeming the entitlement) by customer data monitoring component 206 and/or blockchain-based entitlement redemption component 210.

In some embodiments, the customer data stored in the parameters of the entitlement includes the blockchain wallet ID of the customer blockchain wallet 222 in order to verify the blockchain wallet ID communicated by the customer device 220 matches the blockchain wallet ID stored in the parameters of the blockchain-based entitlement 224 by blockchain-based entitlement redemption component 210. In some embodiments, the parameters may include conditions for redeeming the entitlement 232, such as timeframe for redeeming the entitlement 232, a location for redeeming the entitlement 232, identity verification for redeeming the entitlement 232, and/or customer data conditions, such as customer profile, customer segment, purchase history, and/or any conditions for redeeming the entitlement 232.

Responsive to verifying the identification of the customer blockchain wallet 222 based on the customer data stored in the parameters of the blockchain-based entitlement 224 and/or verifying conditions stored in the parameters the blockchain-based entitlement 224 by blockchain-based entitlement redemption component 210, blockchain-based entitlement redemption component 210 provides the entitlement 232 to the application 230 to cause the application 230 to redeem the entitlement 232. In this regard, the entitlement 232 can be provided to the application 232 to redeem the entitlement 232 as instructions formatted for the technology that is distributing the entitlement. For example, parameters of blockchain-based entitlement 224 may require blockchain-based entitlement redemption component 210 to communicate a yes or no instruction to a hardware scanner (e.g., a touchless scanning device) for entry to a venue or event in communication with an application 230; instructions including a personalized discount rate to the commerce software powering a storefront (e.g., an application 230), and/or the like.

In some embodiments, the entitlement redemption parameters determined by blockchain-based entitlement redemption component 210 may include instructions that are specific to each customer, such as a personalized discount rate based on a personalized entitlement stored in the blockchain-based entitlement 224. In some embodiments, after the entitlement is provided to the application 230, a redemption qualification status indicating that the customer is qualified to redeem the entitlement can be stored by the application 230 for a designated period of time after which the status must be re-verified. In some embodiments, parameters of the blockchain-based entitlement, as designated by the business implementing the blockchain-based entitlement through blockchain-based entitlement customer experience manager 202, can include entitlement scopes, such as whether the entitlement 232 of the blockchain-based entitlement 224 is one-time use (e.g., a single use coupon) or recurring (e.g., 10% off all purchases). In this regard, blockchain-based entitlement customer experience manager 202 can record each redemption in the blockchain-based entitlement 224 on blockchain 216 and update the customer's qualification status. In some embodiments, the token corresponding to the blockchain-based entitlement 224 are burned (e.g., deleted) by blockchain-based entitlement redemption component 210 when entitlements expire. In some embodiments, the token corresponding to the blockchain-based entitlement 224 remain as historical records on blockchain 216 when entitlement expire. In some embodiments, business users can use blockchain-based entitlement customer experience manager 202 to designate how much information about the entitlements is stored in the blockchain-based entitlement (e.g., conditions, customer data, any data related to the entitlement) on blockchain 216 and how much information is stored privately (e.g., on a private blockchain or in data store 212 that is not on a public or private blockchain).

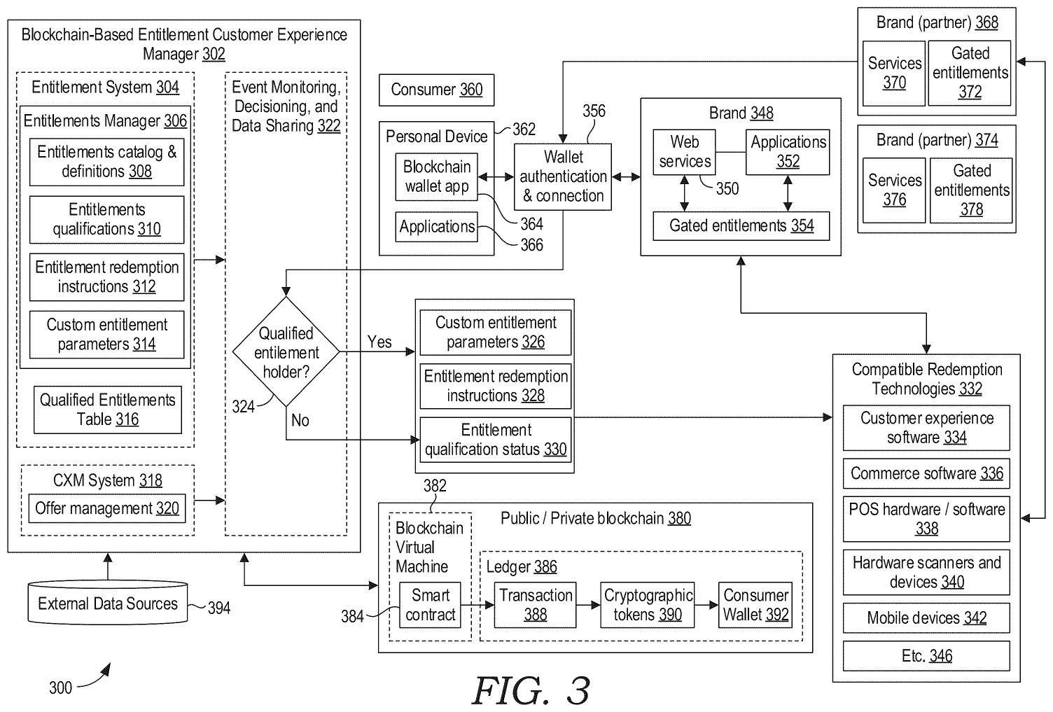

FIG. 3 provides an example diagram of an example model implemented to redeem entitlements deployed on blockchain, in accordance with embodiments described herein. As described herein, such a model can be used to redeem entitlements deployed on blockchain through any technology that is distributing the entitlement in an automated manner. Diagram 300 is an example diagram for an example model implemented to redeem entitlements deployed on blockchain.

As shown, blockchain-based entitlement customer experience manager 302 includes entitlement system 304, customer experience management (CXM) system 318, and component 322 for event monitoring, decisioning, and data sharing. Entitlement system 304 includes entitlement manager 306 and qualified entitlements table 316. Entitlements manager 306 includes entitlements catalog & definitions 308, entitlements qualifications 310, entitlement redemption instructions 312, and custom entitlement parameters 314.

Generally, entitlements manager 306 allows business users (e.g., a business user of a business/brand 348, business/brand partner 368, and/or business/brand partner 374) to define a catalog of consumer entitlements which are contractually guaranteed products and services acquired via blockchain transactions into blockchain-based entitlements. The entitlements can be recorded as blockchain-based entitlements on blockchain 380 (e.g. public and/or private blockchain). For example, a smart contract 384 can be deployed on a blockchain virtual machine 382. When the smart contract 384 is executed, the transaction 388 is recorded on ledger 386 and cryptographic tokens 390 corresponding to the blockchain-based entitlement can be provided to the blockchain consumer wallet 392.

Entitlements catalog & definitions 308 provides an interface to allow a business user to define each product, service, and/or entitlement they wish to employ in commercial transactions with consumers (e.g., customers). For example, the entitlements could be product warranty and support acquired through a purchase, media streaming services or other subscription services, policy benefits from a health, home, auto, or life insurance policy, member loyalty program discounts and rewards, etc. In this regard, the rights, benefits and/or privileges of entitlements and represent the brand's (e.g., business) obligations to consumers under blockchain transactions.

Entitlements qualifications 310 provides an interface to allow a business user to define the qualifying conditions under which a consumer is entitled to receive each entitlement. In some embodiments, the conditions are enforced by compatible redemption technologies 332. For example, consumers (e.g., consumer 360) who possess a fungible or non-fungible token representing an entitlement (e.g., a blockchain-based entitlement) acquired from a brand are entitled to the rights, benefits and/or privileges associated with the entitlement and can authenticate possession of the blockchain wallet by authenticating with the consumer's corresponding blockchain wallet. As another example, brands may define specific timeframes in which consumers are entitled to entitlements. For example, a consumer who belongs to a retailer's loyalty member program may possess a discount token with a personalized discount rate. The retailer can make this discount valid only during the timeframe of the retailer's end-of-year sale, or only on weekends. As another example, brands may define specific locations in which an entitlement may be redeemed requiring consumers to authenticate via a web service or application that has access to location information. As another example, brands can require different forms of identity verification in addition to authenticating the blockchain wallet. The identity verification may include first or third-party identification services and/or services on the consumer's device, such as biometrics. As another example, brands may define ad hoc criteria or employ additional productized criteria defined through custom entitlement parameters 314.

Entitlement redemption instructions 312 provides an interface to allow a business user to define parameters associated with the consumer's entitlement redemption based on a corresponding compatible redemption technology 332 to fulfill the entitlements. Entitlement redemption instructions 312 are formatted for the technology that is distributing the entitlements. For example, instructions may include a yes or no instruction to a hardware scanner for entry to a venue or event, an instruction corresponding to a personalized discount rate to the commerce software powering a storefront, etc.

Custom entitlement parameters 314 provides an interface to allow a business user to define parameters that are specific to each consumer such as a personalized discount rate. The parameters can be based on parameters from an offer management component 320 of a CXM system 320.

The blockchain-based entitlement customer experience manager 302 can communicate a consumer's entitlement qualification status to compatible redemption technologies 332. Compatible redemption technologies 332 can include technology systems gating the distribution of entitlements, such as the brand's own services and/or third-party applications. Compatible redemption technologies 332 can include web services 350, applications 352, POS systems, and/or other connected hardware devices. Examples of compatible redemption technologies 332 include customer experience software 334, commerce software 336, POS hardware/software 338, hardware scanners and devices 340 (e.g., for event entry), mobile devices 342, other hardware/software 346, and/or applications 366 executing on the personal device 362 of the consumer 360.

In some embodiments, the brand 348 can use various hardware and software communication protocols to obtain the consumer's blockchain wallet ID and authentication status, such as HTTP, NFC, Bluetooth, QR Codes, or any other hardware or software communication protocols. In some embodiments, brand 348 can store a redemption qualification status within their services (e.g., web service 350, service 370, or services 376) or on a client device (e.g., a device implementing compatible redemption technologies 332) and determine the timeframe after which the status must be re-verified.

In some embodiments, brand 348 can define entitlement scopes including whether rights, benefits and/or privileges associated with an entitlement are one-time use (e.g., a single use coupon) or recurring (e.g., a 10% off all purchases). In some embodiments, blockchain-based entitlement customer experience manager 302 records each redemption in blockchain 380 and updates the consumer's qualification status in qualified entitlements table 316. In some embodiments, blockchain-based entitlement customer experience manager 302 burns the corresponding blockchain tokens when entitlements expire. In some embodiments, the corresponding blockchain tokens can remain as historical records when entitlements expire. In some embodiments, brand 348 can decide how much information about the entitlements is stored in the blockchain token (as a permanent record) and how much information is stored privately inside blockchain-based entitlement customer experience manager 302.

In some embodiments, blockchain-based entitlement customer experience manager 302 allows a brand 348 to collaborate with one or more partner brands (e.g., partner brand 368 and partner brand 374) to deliver decentralized services to customers. For example, brand 348 may reward their customers with entitlements that are delivered by a partner brand 368 through a partnership. In another example, multiple brands may jointly sell a package that includes services from both partners. In some embodiments, brands may publish or share information about the entitlements within blockchain tokens, which act as verifiable credentials. In some embodiments, brands can select partners or an entire ecosystem of providers to offer their own entitlements to customers, which are contingent upon proof of the credential. In this regard, blockchain-based entitlement customer experience manager 302 allows any set of parties to verify token-based entitlements and deliver related entitlements to the owner of a blockchain wallet.

Blockchain-based entitlement customer experience manager 302 includes component 322 for event monitoring, decisioning, and data sharing. In the example shown in FIG. 3, when a consumer connects their blockchain wallet 392 to a compatible redemption technology 332, a request is sent to the component 322 for event monitoring, decisioning, and data sharing. Component 322 may perform a real-time blockchain query and/or return an asynchronous query result with the consumer's entitlement qualification status 330. Component 322 determines the consumer's entitlement qualification status 330 by evaluating the entitlements qualifications 310 associated with the consumer's entitlement stored in the blockchain token (e.g., the blockchain-based entitlement stored in cryptographic token 390), and any other conditions, such as real-time qualification criteria of time and/or location.

More specifically, a consumer 360 utilizes the personal device 362, which includes a blockchain wallet application 364 and applications 366. The blockchain wallet application 364 is authenticated through wallet authentication and connection component 356 and transmits the blockchain wallet ID of the consumer wallet 392 of the consumer 360 to brand 348 or partner brand 368. Brand 348 utilizes web services 350 and/or application 352, which can provide gated entitlements 354 corresponding to entitlements offered by brand 348 through compatible redemption technologies 332. Partner brand 368 utilizes services 370 (e.g., web services and/or applications), which can provide gated entitlements 372 corresponding to entitlements offered by brand 348 or partner brand 368 through compatible redemption technologies 332. Partner brand 374 utilizes services 376 (e.g., web services and/or applications), which can provide gated entitlements 378 corresponding to entitlements offered by brand 348 or partner brand 374 through compatible redemption technologies 332.

The authenticated blockchain wallet ID of the consumer wallet 392 is communicated by wallet authentication and connection component 356 and/or brand 348 or partner brand 368 to blockchain-based entitlement customer experience manager 302. Using the authenticated blockchain wallet ID of the consumer wallet 392 of the consumer 360, at block 324, it is determined whether the consumer 360 is a qualified entitlement holder based on entitlements qualifications 310 stored in a cryptographic token 390 corresponding to a blockchain-based entitlement associated with the consumer's blockchain wallet ID. In some embodiments, external data sources 394 can be utilized to determine whether the consumer 360 is a qualified entitlement holder. For example, the customer data of consumer 360, such as the consumer's purchase history, can be utilized to determine whether the consumer 360 is a qualified entitlement holder. The custom entitlement parameters 326, entitlement redemption instructions 328, and/or entitlement qualification status 330 is communicated to the compatible redemption technologies 332. The compatible redemption technologies 332 can then provide the corresponding entitlement (e.g., from gated entitlements 354, gated entitlements 372, and/or gated entitlements 378) of the entitlement stored in the blockchain-based entitlement (e.g., cryptographic token 390). The custom entitlement parameters 326, entitlement redemption instructions 328, and/or entitlement qualification status 330 can be stored in qualified entitlements table 316 of blockchain-based entitlement customer experience manager 302.

### Exemplary Implementations for Redeeming Entitlements Deployed on Blockchain

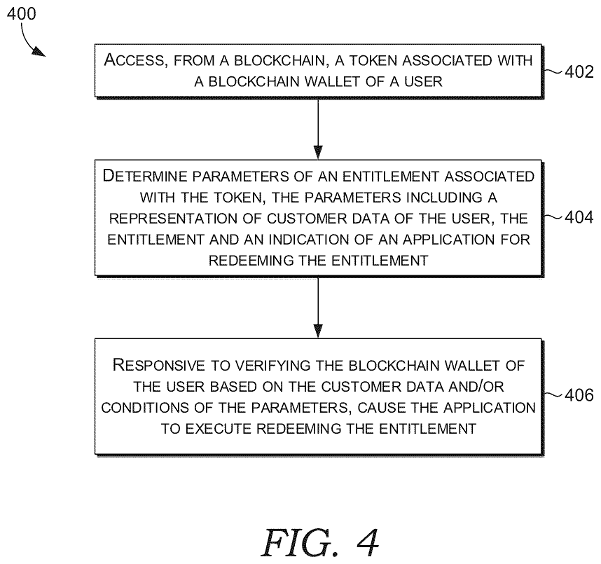

With reference now to FIGS. 4-6, FIGS. 4-6 provide method flows related to facilitating redeeming entitlements deployed on blockchain, in accordance with embodiments of the present technology. Each block of method 400, 500 and 600 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 4-6 are exemplary only and not intended to be limiting. As can be appreciated, in some embodiments, method flows 400-600 can be implemented, at least in part, to facilitate redeeming entitlements deployed on blockchain.

Turning to FIG. 4, a flow diagram 400 is provided showing an embodiment of a method 400 for redeeming entitlements deployed on blockchain, in accordance with embodiments described herein. Initially, at block 402, a token associated with a blockchain wallet of a user is accessed from a blockchain. In some embodiments, the token can be accessed from a public blockchain. In some embodiments, the token can be accessed from a private blockchain. In some embodiments, the accessing of the token associated with a blockchain wallet of a user is in response to a request for entitlement redemption. In some embodiments, the accessing of the token associated with a blockchain wallet of a user occurs at a scheduled interval in order to cause the application to execute redeeming the entitlement asynchronously.

At block 404, parameters of an entitlement associated with the token are determined where the parameters include a representation of customer data of the user, a representation of the entitlement, and an indication of an application for redeeming the entitlement. In some embodiments, the representation of the entitlement can include any number of rights, benefits, and/or privileges of the entitlement. In some embodiments, the parameters and/or the representation of the entitlement can include conditions for redeeming the entitlement. For example, the conditions may include a timeframe for redeeming the entitlement, a location for redeeming the entitlement, and/or identity verification requirement for redeeming the entitlement.

At block 406, responsive to verifying the blockchain wallet of the user based on the customer data and/or verifying conditions of the parameters, the application for redeeming the entitlement executes the redeeming of the entitlement for the user. In some embodiments, the application communicates with hardware associated with the application in order to execute redeeming the entitlement.

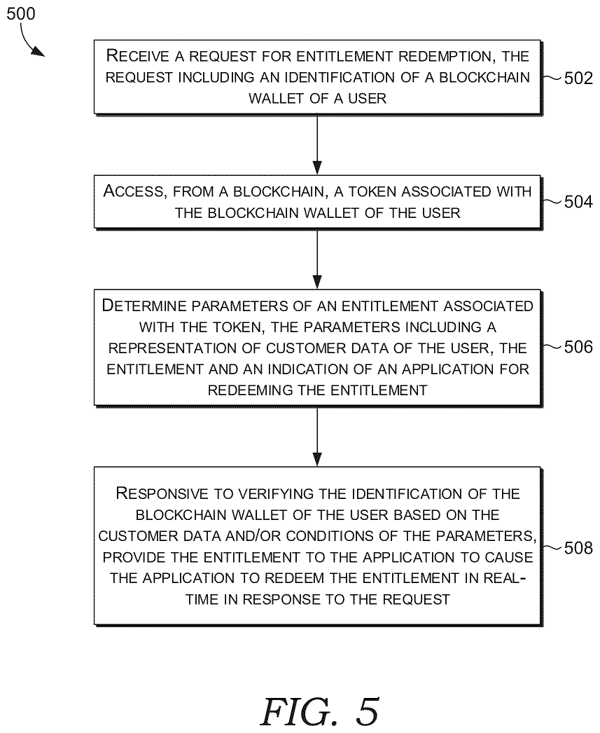

Turning now to FIG. 5, a flow diagram 500 is provided showing an embodiment of a method 500 for redeeming entitlements deployed on blockchain, in accordance with embodiments described herein. Initially, at block 502, a request for entitlement redemption is received where the request includes an identification of a blockchain wallet of a user. In some embodiments, the request is received from a device of the user and the device of the user is used to authenticate the identification of the blockchain wallet of the user. In some embodiments, the request is received from a device executing an application for redeeming the entitlement that is different than the device of the user. In some embodiments, the device executing the application for redeeming the entitlement can communicate with the device of the user in order to receive the identification of the blockchain wallet of the user and/or use the device of the user to authenticate the identification of the blockchain wallet of the user.

At block 504, a token associated with the blockchain wallet of the user is accessed from a blockchain. At block 506, parameters of an entitlement associated with the token are determined where the parameters include a representation of customer data of the user, the entitlement and an indication of an application for redeeming the entitlement. In some embodiments, the parameters include conditions for redeeming the entitlement.

At block 508, responsive to verifying the identification of the blockchain wallet of the user based on the customer data and/or conditions of the parameters, the entitlement is provided to the application for redeeming the entitlement to cause the application to redeem the entitlement in real-time in response to the request. In some embodiments, data is received from the device of the user to verify conditions of the parameters, such as location data and/or data from an identity verification application. In some embodiments, data is received from the device executing the application to verify conditions of the parameters, such as location data and/or data from an identity verification application.

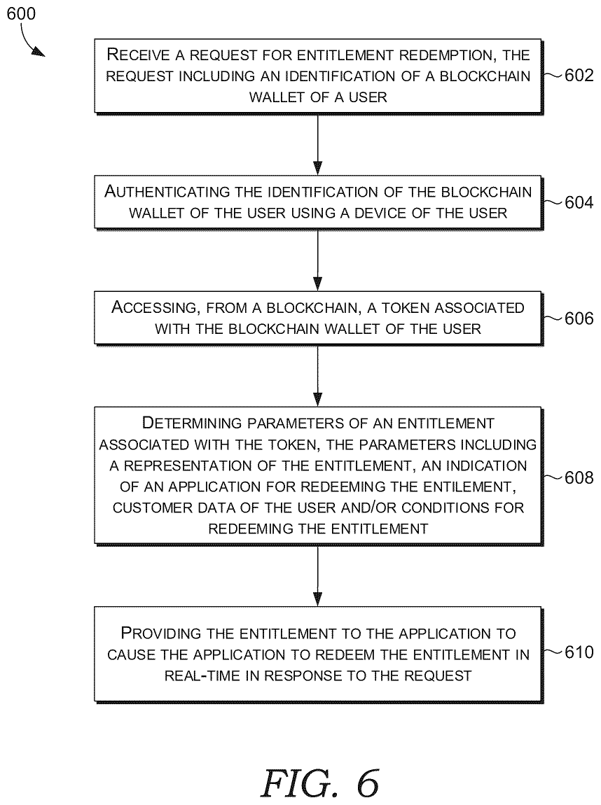

Turning now to FIG. 6, a flow diagram 600 is provided showing an embodiment of a method 600 for redeeming entitlements deployed on blockchain, in accordance with embodiments described herein. Initially, at block 602, a request for entitlement redemption is received where the request includes an identification of a blockchain wallet of a user. At block 604, the identification of the blockchain wallet of the user is authenticated using a device of the user. For example, the user may utilize a blockchain wallet website and/or application executing on the device of the user to authenticate the identification of the blockchain wallet of the user.

At block 606, a token associated with the blockchain wallet of the user is accessed from a blockchain. At block 608, parameters of an entitlement associated with the token are determined where the parameters include a representation of the entitlement, an indication of an application for redeeming the entitlement, customer data of the user and/or conditions for redeeming the entitlement. At block 610, the entitlement is provided to the application for redeeming the entitlement to cause the application to redeem the entitlement in real-time in response to the request.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein. Neither should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 7 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, and optical-disc drives. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, and vibrating component. I/O port(s) 718 allow computing device 700 to be logically coupled to other devices including I/O components 720, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 700. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. One or more computer-readable media having a plurality of executable instructions embodied thereon, which, when executed by one or more processors, cause the one or more processors to perform a method comprising:
accessing from a blockchain, via a blockchain-based entitlement accessing component, a token associated with a blockchain wallet of a user;
determining, via a blockchain-based entitlement redemption component, a plurality of parameters of an entitlement associated with the token, the plurality of parameters comprising a representation of customer data of the user, a representation of the entitlement, and an indication of an application for redeeming the entitlement; and
responsive to verifying, via the blockchain-based entitlement redemption component, the blockchain wallet of the user based on at least a portion of the representation of the customer data, causing the application to execute redeeming the entitlement.

2. The media of claim 1, the method further comprising:
receiving a request for entitlement redemption from a device of the user;
using the device of the user to authenticate an identification of the blockchain wallet of the user; and
causing the application to execute redeeming the entitlement in real-time in response to the request.

3. The media of claim 1, the method further comprising:
receiving, via the application, an identification of the blockchain wallet of the user from a device of the user; and
causing the application to execute redeeming the entitlement in real-time in response to receiving the identification of the blockchain wallet of the user.

4. The media of claim 1, the method further comprising:
accessing the token associated with the blockchain wallet of the user at a scheduled interval in order to cause the application to execute redeeming the entitlement asynchronously.

5. The media of claim 3, wherein a representation of the plurality of parameters of the entitlement is stored in the token.

6. The media of claim 1, the method further comprising:
verifying via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from a device of the user to verify the condition.

7. The media of claim 1, the method further comprising:
verifying, via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from a device executing the application to verify the condition.

8. The media of claim 1, wherein the application communicates with hardware associated with the application in order to execute redeeming the entitlement.

9. A computer-implemented method comprising:
receiving, via a blockchain-based entitlement accessing component, a request for entitlement redemption, the request comprising an identification of a blockchain wallet of a user;
accessing from a blockchain, via the blockchain-based entitlement accessing component, a token associated with the blockchain wallet of the user;
determining, via a blockchain-based entitlement redemption component, a plurality of parameters of an entitlement associated with the token, the plurality of parameters comprising a representation of customer data of the user, a representation of the entitlement, and an indication of an application for redeeming the entitlement; and
responsive to verifying, via the blockchain-based entitlement redemption component, the identification of the blockchain wallet of the user based on at least a portion of the representation of the customer data:
providing, via the blockchain-based entitlement redemption component, at least a portion of the representation of the entitlement to the application to cause the application to execute redeeming the entitlement in real-time in response to the request.

10. The computer-implemented method of claim 9, further comprising:
receiving the request for entitlement redemption from a device of the user; and
using the device of the user to authenticate the identification of the blockchain wallet of the user.

11. The computer-implemented method of claim 9, further comprising:
receiving the request for entitlement redemption from the application; and
using a device of the user to authenticate the identification of the blockchain wallet of the user before transmitting the request by the application.

12. The computer-implemented method of claim 11, wherein a representation of the plurality of parameters of the entitlement is stored in the token.

13. The computer-implemented method of claim 9, further comprising:
verifying, via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from the device of the user to verify the condition.

14. The computer-implemented method of claim 9, further comprising:
verifying, via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from a device executing the application to verify the condition.

15. The computer-implemented method of claim 9, wherein the application communicates with hardware associated with the application in order to execute redeeming the entitlement.

16. A computing system comprising:
a processor; and
a non-transitory computer-readable medium having stored thereon instructions that when executed by the processor, cause the processor to perform operations including:
receiving, via a blockchain-based entitlement accessing component, a request for entitlement redemption, the request comprising an identification of a blockchain wallet of a user;
authenticating, via an authentication component, the identification of the blockchain wallet of the user using a device of the user;
accessing from a blockchain, via the blockchain-based entitlement accessing component, a token associated with the blockchain wallet of the user;
determining, via a blockchain-based entitlement redemption component, a plurality of parameters of an entitlement associated with the token, the plurality of parameters comprising a representation of the entitlement and an indication of an application for redeeming the entitlement; and
providing, via the blockchain-based entitlement redemption component, the representation of the entitlement to the application to cause the application to execute redeeming the entitlement in real-time in response to the request.

17. The system of claim 16, wherein a representation of the plurality of parameters of the entitlement is stored in the token and the request is received from at least one of the device of the user and the application.

18. The system of claim 16, the instructions that when executed by the processor, cause the processor to perform operations further including:
verifying, via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from the device of the user to verify the condition

19. The system of claim 16, the instructions that when executed by the processor, cause the processor to perform operations further including:
verifying, via the blockchain-based entitlement redemption component, a condition for redeeming the entitlement before causing the application to execute redeeming the entitlement, the condition comprising at least one of a timeframe for redeeming the entitlement, a location for redeeming the entitlement, and identity verification for redeeming the entitlement; and
receiving data from a device executing the application to verify the condition.

20. The system of claim 16, wherein the application communicates with hardware associated with the application in order to execute redeeming the entitlement.
